(19) United States
(12) Patent Application Publication
(10) Pub. No.: US 2005/0286699 A1
(43) Pub. Date: Dec. 29, 2005

(54) System and method for automatic conferencing

(76) Inventor: Michael D. Gagle, Knox, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/873,345

(22) Filed: Jun. 22, 2004

(51) Int. Cl. H04M 3/42

(52) U.S. Cl. 379/202.01

(57) ABSTRACT

A computer system and method is disclosed for automatically conferencing a third party to a communication channel between a first and second party. A computer telephony system establishes a communication channel between a first and second party. The computer telephony system receives incoming communication from a third party that is directed to the first party. If an auto-conference indicator is set for the phone being operated by the first party, then the third part is automatically connected to the communication between the first and second party after an announcement is played to the first and second party. A computer graphical user interface can be used to enable or disable the auto-conference indicator.

### BACKGROUND

The present invention relates to communication processing, and more particularly, but not exclusively, relates to automatically conferencing a third or subsequent party to a communication channel between a first and second party.

Conference calls between three or more parties are frequently used in today's business world. Conference calls can be setup in a variety of ways. As one example, a party who is on the phone can place the other party on hold while yet another party is connected. As another example, the call waiting feature can indicate an incoming call and the receiving party can take various actions to accept the incoming call and join it to the call already in progress. Yet another example involves setting up a conference with a conference service and having all parties call that virtual number at the conference time. All of these conferencing options require numerous steps to be taken to setup and/or accept the conference call. Further advancements are still needed in these areas.

### SUMMARY

One embodiment of the present invention is a unique communication technique. Other embodiments include unique systems, apparatus, devices, and methods for processing communications.

A further embodiment includes a technique for automatically conferencing a third party to a communication between a first and second party. In one particular form, the third party telephones the first party and is automatically conferenced with the first and second party.

Another embodiment includes: establishing a telephone communication channel between a first party and a second party with a computer telephony system. An incoming communication is received from a third party and is directed to a phone number associated with a phone being operated by the first party. An announcement is played of the incoming communication to the first party and the second party if an auto-conference indicator is enabled for the phone being operated by the first party. The third party is automatically and unconditionally added to the communication channel between the first party and the second party. The communication channel can be based on standard Public Switched Telephone Network (PSTN) telephone lines, wireless telephone, and/or a publicly accessible computer network, such as the internet, to provide an aurally perceived communication, to name just a few examples.

Accordingly, one object of the present invention is to provide a unique communication technique.

Another object of the present invention is to provide a unique system, apparatus, device, or method for processing communications.

Further forms, objects, features, aspects, benefits, advantages, and embodiments of the present invention shall become apparent from the detailed description and drawings provided herewith.

### BRIEF DESCRIPTION OF THE DRAWINGS

FIG. 1 is a schematic view of a communication system.

FIG. 2 is a flowchart of one procedure that can be implemented with the system of FIG. 1.

FIG. 3 is a partial diagrammatic view of a user station of FIG. 1 with Graphical User Interface (GUI) controls to enable or disable an auto-conference indicator and access code in accordance with the procedure of FIG. 2.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

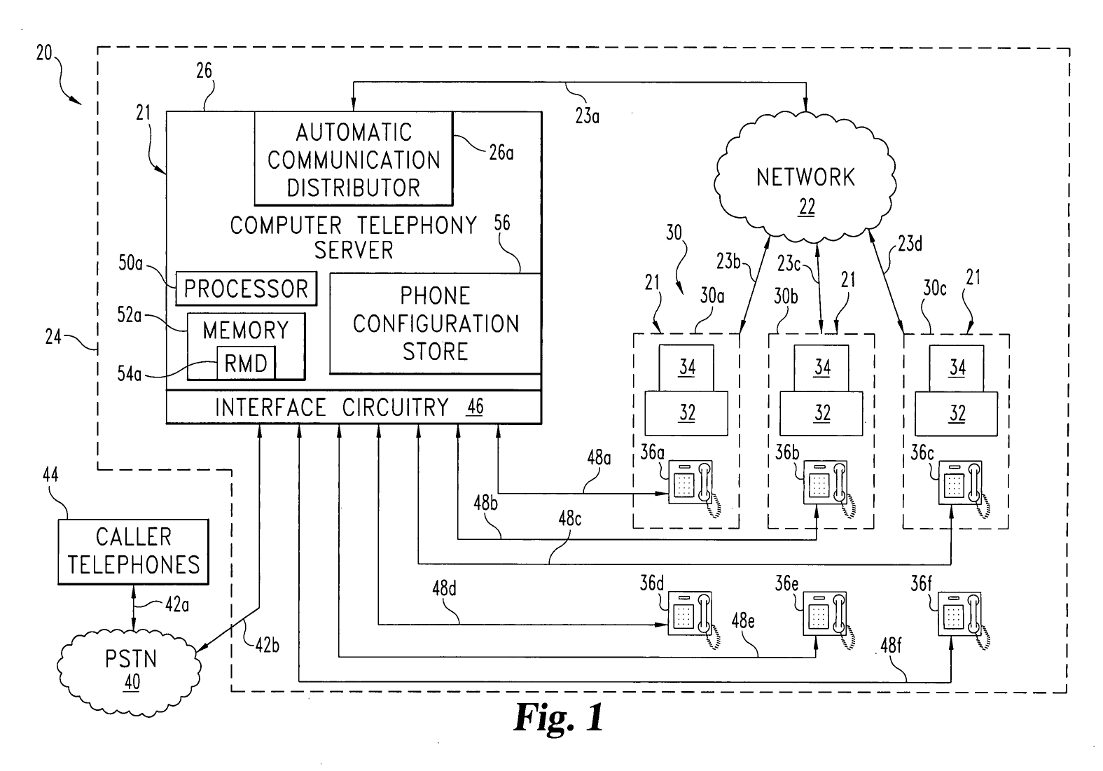

FIG. 1 is a diagrammatic view of computer system 20 of one embodiment of the present invention. Computer system 20 includes computer network 22. Computer network 22 couples together a number of computers 21 over network pathways 23. More specifically, system 20 has one or more servers, including Computer Telephony (CT) server 26 and user client workstations 30a, 30b, and 30c. CT server 26 includes hardware and/or software to define an Automated Communication Distributor (ACD) 26a. While computers 21 are each illustrated as being a server or client, it should be understood that any of computers 21 may be arranged to include both a client and server. Furthermore, it should be understood that while four computers 21 are illustrated, more or fewer may be utilized in alternative embodiments.

CT server 26 includes one or more processors or CPUs 50a and memory 52a that can be comprised of one or more types. Memory 52a includes a removable memory device (RMD) 54a. Although not shown to preserve clarity, each computer 21 of system 20 includes one or more processors or CPUs and one or more types of memory. Each processor may be comprised of one or more components configured as a single unit. Alternatively, when of a multi-component form, a processor may have one or more components located remotely relative to the others. Such components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory (removable or generic) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disk memory (such as a DVD or CD ROM); a magnetically encoded hard disk, floppy disk, tape, or cartridge media; or a combination of any of these memory types. Also, each memory may be volatile, nonvolatile, or a hybrid combination of volatile and nonvolatile varieties.

System 20 further illustrates Public Switched Telephone Network (PSTN) 40 coupled to interface circuitry 46 of server 26 by pathway 42b. For this embodiment, interface circuitry 46 is a computer controlled switch that is in the form of one or more telephone communication processing boards, such as those offered by INTEL Corporation under the DIALOGIC® brand, or by ACULAB. Caller telephones 44 are coupled to PSTN 40 by pathway 42a. Interface circuitry 46 is also coupled to telephone communication devices 36a, 36b, 36c, 36d, 36e, and 36f (collectively designated as telephones 36) by pathways 48a, 48b, 48c, 48d, 48e, and 48f. For the sake of clarity, interface circuitry 46 is shown coupled to multiple telephones 36. However, it should be understood that each of telephones 36 may be coupled to one or more interface circuitries and that one or more interface circuitries 46 may be located at one or more physical locations. Interface circuitry 46 may be arranged in the form of hardware for a Private Branch Exchange (PBX), predictive dialer, Automatic Communication Distributor (ACD), a combination of these, or another switching configuration as would occur to those skilled in the art. Telephones 36 may be in the form of a handset, headset, or other arrangement as would occur to those skilled in the art. Telephones 36a, 36b, and 36c are each associated with a different one of user workstations 30a, 30b, and 30c, respectively (collectively designated user workstations 30). Telephones 36d, 36e, and 36f are standalone telephones that are not associated with any user workstation. As one non-limiting example, one or more of standalone telephones 36d, 36e, or 36f may be located in a conference room or other such location. User workstations 30 each include a user computer 32 coupled to a display 34. In one embodiment, user workstations 30 are used to administer the settings of one or more telephones 36. Alternatively or additionally, a user, such as an administrator, can use one or more of user workstations 30a, 30b, or 30c to administer the settings of standalone telephones 36d, 36e, and 36f. User computers 32 may be of the same type, or a heterogeneous combination of different computing devices. Likewise, displays 34 may be of the same type, or a heterogeneous combination of different visual devices. Although not shown to preserve clarity, each user workstation 30 may also include one or more operator input devices such as a keyboard, mouse, track ball, light pen, and/or microtelecommunicator, to name just a few representative examples. Also, besides display 34, one or more other output devices may be included such as loudspeaker(s) and/or a printer.

Computer network 22 can be in the form of a Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22. It should also be recognized that computer network 22 may include one or more elements of PSTN 40. Indeed, in an alternate embodiment, PSTN 40 and computer network 22 are provided as a common network.

In one embodiment, system 20 operates as a communication system 24 at one or more physical locations that are remote from one another with server 26 being configured as an automatic communication distributor server host. While ACD 26a is shown defined by server 26, in other embodiments may only partially be defined by server 26 and/or defined with one or more other servers. Likewise, a common server (such as server 26) or other servers can be provided for computer network management, e-mail, facsimile, and the like. In one embodiment, Server 26 includes phone configuration store 56 that can be used by ACD 26a to determine the configuration settings of telephones 36. Alternatively or additionally, phone configuration store 56 could also be located on one or more other servers. User workstations 30a, 30b, and 30c are each arranged as a communication client host. Additional telephones 36 may be connected to interface circuitry 46 and can be standalone or can correspond to an additional client host to provide more user workstations 30 (not shown). Typically communication system 20 would include many more user workstations of this type at one or more physical locations, but only a few have been illustrated in FIG. 1 to preserve clarity. Also, one or more servers 26 may be configured as a communication distributor server host at one or more physical locations.

Alternatively or additionally, system 20 may be arranged to provide for distribution and routing of a number of different forms of communication, such as telephone calls, voice mails, faxes, e-mail, web chats, web call backs, and the like. Furthermore, business/customer data associated with various communications may be selectively accessed with system 20. This data may be presented to a user at each user workstation 30 by way of monitor 34 operatively coupled to the corresponding user computer 32.

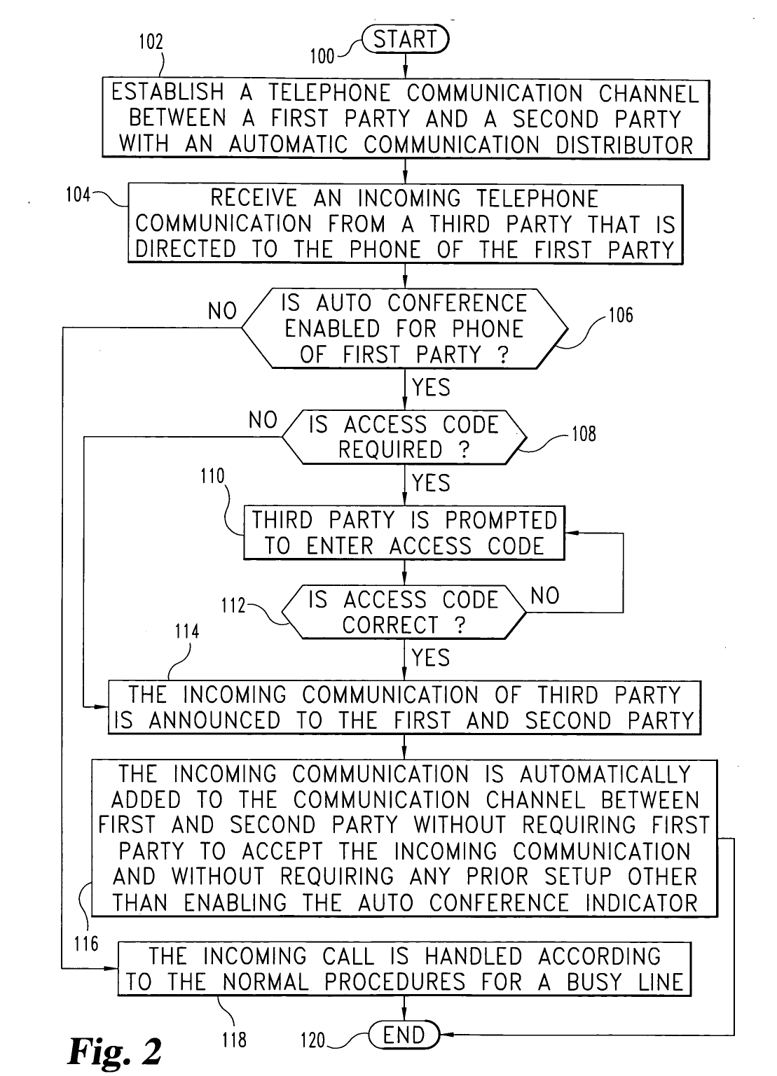

Referring additionally to FIG. 2, one embodiment for implementation with system 20 is illustrated in flow chart form as procedure 100, which demonstrates a process for automatically conferencing a third party to a communication channel between a first and second party. In one form, procedure 100 is at least partially implemented in the operating logic of system 20, particularly server 26. Such logic can be in the form of software instructions, firmware instructions, dedicated hardware, or a combination of these.

Procedure 100 begins with automatic communication distributor server 26 establishing a telephone communication channel between a first party and a second party (stage 102). For illustration purposes, assume that first party is using telephone 36d. The second party can be using an external caller telephone 44 or another of telephones 36. Either the first party or the second party could have initiated the communication. Automatic communication distributor server 26 receives an incoming telephone communication from a third party that is directed to telephone 36d of the first party (stage 104). Third party can be calling from an external caller telephone 44, or from one of the remaining telephones 36 of communication system 24. Since the phone of the first party is currently in use (busy), automatic communication distributor server 26 determines whether an auto-conference indicator is enabled for telephone 36d of the first party (decision point 106). If the auto-conference indicator is disabled, then the incoming call is handled according to the normal procedures for a line in use, such as providing a busy signal to the third party or transferring the incoming communication to the first party's voice mail, as a few non-limiting examples (stage 118). If the auto-conference indicator is enabled (decision point 106), then automatic communication distributor server 26 determines whether an access code from the third party is required (decision point 108). If an access code is required for telephone 36d of the first party (decision point 108), then the third party is prompted to enter an access code (stage 110). If an incorrect access code is entered (decision point 112), then the third party is again prompted to enter an access code (stage 110). Once a correct access code is entered (decision point 112) the process then continues. If the access code was not required or if it was entered correctly, then the incoming communication of the third party is announced to the first and/or second party over the communication channel (stage 114). The incoming communication is then automatically added to the communication channel between the first and second party (stage 116). The incoming call is unconditionally added to the communication channel, regardless of the caller identification or location of the third party. The first party does not have to take any action to accept the incoming communication and did not have to take prior steps to setup the conference other than enabling the auto-conference indicator and optionally the access code for telephone 36d using a graphical user interface corresponding user workstation 30a (stage 116). Although the process describes adding third party to an existing communication channel between the first party and the second party, additional parties can be automatically conferenced using the same procedure. The process then ends at stage 120.

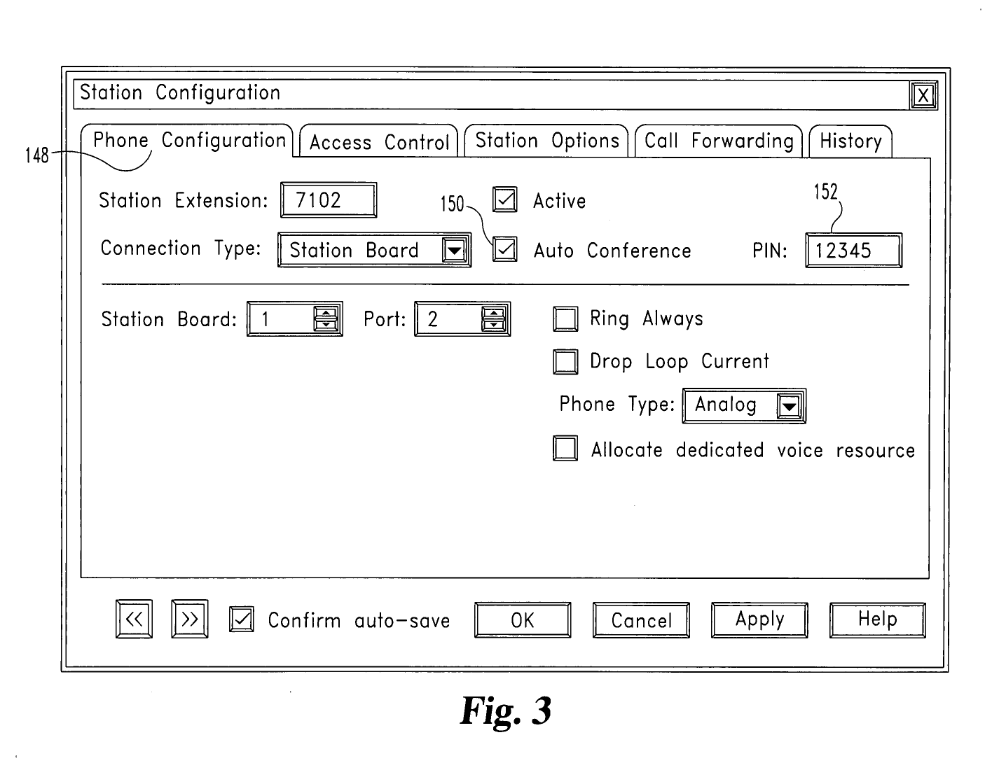

FIG. 3 is a partial diagrammatic view of the user station 30 of FIG. 1 with Graphical User Interface (GUI) controls to view and modify the auto-conference and access code settings in accordance with the procedure of FIG. 2. A phone configuration tab 148 displays a variety of phone settings for the particular telephone station. Auto-conference indicator 150 can be enabled or disabled to control whether a third party can be automatically added to an existing communication between two parties. In the current example, auto-conference indicator 150 is enabled. Access code or pin 152 can be specified for the telephone station so that the third party will be required to enter access code 152 before an automatic conference call to an existing communication will be established. In the current example, access code 152 is set to a value of “12345”. One of skill in the art will appreciate that this screen could be designed in various ways that would allow for viewing and modifying a plurality of settings for telephones 36. Alternatively or additionally, a setting can be included that controls which of the existing parties will hear the notification of the incoming communication that is being automatically conferenced to the communication between the existing parties.

A hypothetical scenario will be described with reference to FIGS. 1-3. For example, suppose that communication center 20 operates to handle telephone and other communications for a company. Telephone 36d is located in a conference room in one of the company buildings. Using workstation 30b, an administrator using GUI controls on phone configuration tab 148 has enabled auto-conference indicator 150 for telephone 36d. Also, the administrator specified that an access code must be entered by a third party before auto-conferencing will be allowed with telephone 36d. To specify the requirement for an access code, the administrator entered a value of “12345” for access code/PIN field 152.

The first, second, and third parties have decided to have a conference call at a certain time. Using the automatic conferencing features of the current invention, one of the parties will automatically be joined to the call in progress between the other two parties. The first party will be in the conference room, the second party will be participating from telephone 36a from his office in the same building, and the third party will be participating from external caller telephone 44 from a totally different geographical location. The parties agree that to join the conference the second and third parties will simply call telephone 36d in the conference room and will need to enter the access code “12345” to join the conference if it is already in session. When the conference time arrives, automatic communication distributor server 26 receives a request from telephone 36a of the second party to call telephone 36d in the conference room and establishes the telephone communication channel (stage 102) because the conference room phone is not currently in use. Automatic communication distributor server 26 then receives an incoming telephone communication from a third party from external caller telephone 44 that is directed to telephone 36d in the conference room (stage 104). Since an existing call is already in session on telephone 36d, automatic communication distributor server 26 retrieves settings for telephone 36d from phone configuration store 56 and determines that auto-conference indicator 150 is enabled for telephone 36d of the first party (decision point 106). Automatic communication distributor server 26 also determines that access code 152 from the third party is required (decision point 108). The third party is prompted to enter access code 152 (stage 110). After third party enters the required value of “12345” (stage 112), the incoming communication of the third party is announced to the first and/or second party over the communication channel (stage 114). The incoming communication is then automatically added to the communication channel between the first and second party (stage 116). The incoming communication was added to the conference without being selective as to caller identification or location of the third party. The first party in the conference room did not have to take any action to accept the incoming communication. The first party did not have to take prior steps to setup the conference other than having someone enable the auto-conference indicator and optionally setup the access code for telephone 36d using the phone configuration tab 148 of GUI on a user workstation 30 (stage 116).

Alternatively or additionally, the communication channel can be based on standard Public Switched Telephone Network (PSTN) telephone lines, wireless telephone, and/or a publicly accessible computer network, such as the internet, to provide voice or another aurally-perceived form of communication, to name just a few examples.

In one embodiment, a method is disclosed that comprises establishing a telephone communication channel between a first party and a second party with a computer telephony system. An incoming telephone communication is received from a third party that is directed to a phone number associated with a phone being operated by the first party. If an auto-conference indicator is enabled for the phone being operated by the first party, the third party is automatically and unconditionally added to the communication channel between the first party and the second party.

In another embodiment, a method is disclosed that comprises: providing a third party with an access code that will be required before the third party will automatically be conferenced into an in-process telephone communication between a first party and another party. A telephone communication channel is established between the first party and a second party with a computer telephony system. An incoming telephone communication is received from a third party that is directed to a phone number associated with a phone being operated by the first party. The third party is prompted to enter the correct access code and upon receiving the correct access code from the third party, the third party is automatically added to the communication channel between the first party and the second party.

In another embodiment, a system is disclosed that comprises a number of user stations, the user stations each including one of a number of computer terminals; a number of telephone communication devices, at least one of the number of telephone communication devices corresponding to at least one of the number of user stations; telephonic interface circuitry coupled to a public switched telephone network and each of the telephone communication devices by a corresponding number of telephone lines; and one or more servers coupled to the user stations by a computer network and the interface circuitry. The one or more servers are operable to provide an computer telephony system to establish a communication channel between a first party and a second party, and if an auto-conference indicator is enabled for a phone being operated by the first party, to automatically and unconditionally connect an incoming communication of a third party to the communication channel between the first party and the second party.

In yet another embodiment, a method is disclosed that comprises establishing a telephone communication channel is established between a first party and a second party with a computer telephony system. An incoming communication is received from a third party that is directed to a phone number associated with a phone being operated by the first party. If an auto-conference indicator and a required access code setting are enabled for the phone being operated by the first party, the third party is prompted to enter a correct access code. Upon receiving the correct access code from the third party, an announcement is played of the incoming communication to the first party and the second party and the third party is automatically added to the communication channel between the first party and the second party.

In a further embodiment, an apparatus is disclosed that comprises a device encoded with logic executable by one or more processors to: establish a telephonic communication channel between a first party and a second party using a computer telephony system, to receive an incoming telephonic communication from a third party directed to the first party, and if an auto-conference indicator is enabled for a phone being operated by the first party to automatically and unconditionally connect the incoming telephonic communication of the third party to the telephonic communication channel between the first party and the second party.

Still another embodiment includes: preparing for a teleconference by enabling an auto-conference indicator for a telephone with a computer telephony system and providing a party access information to join the teleconference; initiating the teleconference between two or more other parties with the computer telephony system; and automatically adding the party to the teleconference with the two or more other parties in response to receiving the a telephone call from the party that is directed to the telephone. In one form, this automatic addition of the party to the teleconference can be performed independent of and/or without regard to any caller identification information provided by the telephone call. All publications, patents, and patent applications cited in this specification are herein incorporated by reference as if each individual publication, patent, or patent application were specifically and individually indicated to be incorporated by reference and set forth in its entirety herein. While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected.

1. A method comprising:
establishing a telephone communication channel between a first party and a second party with a computer telephony system;
receiving an incoming telephone communication from a third party that is directed to a phone number associated with a phone being operated by the first party; and
if an auto-conference indicator is enabled for the phone being operated by the first party, automatically and unconditionally adding the third party to the communication channel between the first party and the second party.

2. The method of claim 1, wherein prior to adding the incoming communication of the third party to the communication channel between the first party and the second party, an announcement of the incoming communication is played to the first party and the second party.

3. The method of claim 1, wherein the auto-conference indicator for the phone being operated by the first party can be enabled or disabled using a computer graphical user interface that controls a plurality of settings for the phone being operated by the first party.

4. The method of claim 1, wherein the phone being operated by the first party is located in a conference room.

5. A method, comprising:
preparing for a teleconference by enabling an auto-conference indicator for a telephone with a computer telephony system and providing a party access information to join the teleconference, the access information including a telephone number for the telephone;
after said preparing, initiating the teleconference between two or more other parties with the computer telephony system, one of the two or more other parties using the telephone during the teleconference; and
automatically adding the party to the teleconference with the two or more other parties in response to receiving a telephone call from the party that is directed to the telephone, if caller identification information is provided by the telephone call, said automatically adding being performed independent of the caller identification information.

6. The method of claim 5, which includes receiving a teleconference access code from the party before performing said automatically adding.

7. The method of claim 5, wherein the caller identification information is provided by the telephone call and identifies an individual other than the party.

8. The method of claim 5, which includes disabling the auto-conference indicator for the telephone after the teleconference.

9. A system comprising:
a number of user stations, the user stations each including one of a number of computer terminals;
a number of telephone communication devices, at least one of the number of telephone communication devices corresponding to at least one of the number of user stations;
telephonic interface circuitry coupled to a public switched telephone network and each of the telephone communication devices by a corresponding number of telephone lines; and
one or more servers coupled to the user stations by a computer network and the interface circuitry, the one or more servers being operable to provide a computer telephony system to establish a communication channel between a first party and a second party, and if an auto-conference indicator is enabled for a phone operated by the first party, to automatically and unconditionally connect an incoming communication of a third party to the communication channel between the first party and the second party.

10. The system of claim 9, wherein the one or more servers are further operable to play an announcement of the incoming communication to the first party and the second party prior to adding the incoming communication of the third party to the communication channel between the first party and the second party.

11. The system of claim 9, wherein each of the user stations includes a respective one of a number of displays, and is operable to present a graphical user interface that allows a user to enable or disable an auto-conference indicator that is used to control whether automatic conferencing is allowed for a respective one of the telephone communication devices.

12. A method comprising:
establishing a telephone communication channel between a first party and a second party with an computer telephony system;
receiving an incoming communication from a third party that is directed to a phone number associated with a phone being operated by the first party; and
if an auto-conference indicator and a required access code setting are enabled for the phone being operated by the first party, prompting the third party to enter an access code; and
upon receiving the access code from the third party, automatically adding the third party to the communication channel between the first party and the second party.

13. The method of claim 12, wherein the required access code setting for the phone being operated by the first party can be specified using a graphical user interface that controls a plurality of settings for the phone being operated by the first party.

14. The method of claim 12, wherein the auto-conference indicator for the phone being operated by the first party can be enabled using a computer graphical user interface that controls a plurality of settings for the phone being operated by the first party.

15. The method of claim 12, wherein the phone being operated by the first party is located in a conference room.

16. The method of claim 12, wherein the first party and the second party and the third party are in different geographical locations.

17. The method of claim 12, wherein the first party and the second party and the third party are located in a same geographic location.

18. An apparatus, comprising: a device encoded with logic executable by one or more processors to: establish a telephonic communication channel between a first party and a second party using a computer telephony system, to receive an incoming telephonic communication from a third party directed to the first party, and if an auto-conference indicator is enabled for a phone being operated by the first party to automatically and unconditionally connect the incoming telephonic communication of the third party to the telephonic communication channel between the first party and the second party.

19. The apparatus of claim 18, wherein the device includes a removable memory device carrying a number of processor executable instructions to define the logic.

20. The apparatus of claim 19, wherein the removable memory device includes a disk.

21. The apparatus of claim 18, wherein the device is in the form of one or more parts of a computer network carrying one or more signals encoding the logic.
